(19) United States
(12) Patent Application Publication
(10) Pub. No.: US 2026/0253523 A1
(43) Pub. Date: Aug. 27, 2026

(54) DISPLAY APPARATUS, METHOD OF DRIVING THE SAME AND ELECTRONIC APPARATUS INCLUDING THE SAME

(71) Applicant: SAMSUNG DISPLAY CO., LTD., YONGIN-SI (KR)

(72) Inventor: YANGUK NAM, Yongin-si (KR)

(21) Appl. No.: 19/382,585

(22) Filed: Nov. 7, 2025

(30) Foreign Application Priority Data
Feb. 26, 2025 (KR) 10-2025-0025247

(51) Int. Cl. G09G 3/20

(52) U.S. Cl. CPC G09G 3/20; G09G 2320/0247; G09G 2320/06; G09G 2330/021; G09G 2330/027

(57) ABSTRACT

A display apparatus includes a display panel and a power voltage generator. The power voltage generator is configured to output a power voltage to the display panel. The power voltage generator includes a discharge switching element connected to an output terminal of the power voltage generator and a discharge controller connected to a control electrode of the discharge switching element. One of a first logic power voltage and a second logic power voltage is selectively applied to the discharge controller.

### CROSS-REFERENCE TO RELATED APPLICATION(S)

This U.S. patent application claims priority under 35 U.S.C. § 119 to Korean Patent Application No. 10-2025-0025247, filed on Feb. 26, 2025, in the Korean Intellectual Property Office KIPO, the disclosure of which is incorporated by reference in its entirety herein.

### 1. TECHNICAL FIELD

Embodiments of the present inventive concept are directed to a display apparatus, a method of driving the display apparatus and an electronic apparatus including the display apparatus. More particularly, embodiments of the present inventive concept are directed to a display apparatus having a fast discharge function, a method of driving the display apparatus and an electronic apparatus including the display apparatus.

### 2. DISCUSSION OF RELATED ART

A display apparatus may include a display panel and a display panel driver. The display panel displays an image based on input image data. The display panel includes a plurality of gate lines, a plurality of data lines and a plurality of pixels. The display panel driver includes a gate driver, a data driver, a power voltage generator and a driving controller. The gate driver outputs gate signals to the gate lines. The data driver outputs data voltages to the data lines. The power voltage generator outputs a power voltage to the display panel. The driving controller controls an operation of the gate driver, an operation of the data driver and an operation of the power voltage generator.

When the display apparatus is powered down, circuitry may be provided to discharge voltages applied to the display panel. This discharge is intended to prevent line light-emission, in which certain lines of the display panel remain visibly lit during power-down, thereby reducing display quality. However, if the display apparatus powers down due to a sudden drop in supply voltage, internal logic of the power voltage generator may be disabled before the panel voltages are fully discharged. As a result, residual charge may remain, unwanted light emission may occur, and overall display quality may deteriorate.

### SUMMARY

Embodiments of the present inventive concept provide a display apparatus with a function to discharge a power voltage of a display panel, a method of driving the display apparatus, and an electronic device including the display apparatus. The function may quickly discharge the power voltage when the display apparatus is turned off or when an input power voltage drops suddenly, by selectively applying either a first logic power voltage or a second logic power voltage.

In an embodiment of a display apparatus according to the present inventive concept, the display apparatus includes a display panel and a power voltage generator. The power voltage generator is configured to output a power voltage to the display panel. The power voltage generator includes a discharge switching element connected to an output terminal of the power voltage generator and a discharge controller connected to a control electrode of the discharge switching element. The power voltage generator is configured to apply one of a first logic power voltage or a second logic power voltage to the discharge controller.

In an embodiment, the first logic power voltage may be an input power voltage of the power voltage generator. The second logic power voltage may be an output power voltage of the output terminal of the power voltage generator.

In an embodiment, the discharge controller may be configured to receive a fault signal indicating an abnormal operation of the display apparatus, an inverted enable signal indicating that an input power voltage is equal to or less than a logic threshold voltage and a fast discharge enable signal indicating whether to discharge the power voltage.

In an embodiment, the discharge controller may include a first comparator, a first OR gate and a first AND gate. The first comparator may include a first input terminal configured to receive one of the first logic power voltage and a second logic power voltage and a second input terminal configured to receive an operation threshold voltage. The first OR gate may include a first input terminal configured to receive the fault signal and a second input terminal configured to receive the inverted enable signal. The first AND gate may include a first input terminal connected to an output terminal of the first comparator, a second input terminal configured to receive the fast discharge enable signal and a third input terminal connected to an output terminal of the first OR gate. An output terminal of the first AND gate may be connected to the discharge switching element.

In an embodiment, when a logic power voltage of the discharge controller is determined as the first logic power voltage and when the first logic power voltage is equal to or greater than the operation threshold voltage, a fast discharge function may be enabled. When the logic power voltage of the discharge controller is determined as the first logic power voltage and when the first logic power voltage is less than the operation threshold voltage, the fast discharge function may be disabled.

In an embodiment, when a logic power voltage of the discharge controller is determined as the second logic power voltage and when the second logic power voltage is equal to or greater than the operation threshold voltage, a fast discharge function may be enabled. When the logic power voltage of the discharge controller is determined as the second logic power voltage and when the second logic power voltage is less than the operation threshold voltage, the fast discharge function may be disabled.

In an embodiment, the power voltage generator may further include a second comparator, a third comparator, a second OR gate, a first switching element and a second switching element. The second comparator may include a first input terminal configured to receive the first logic power voltage and a second input terminal configured to receive the logic threshold voltage. The third comparator may include a first input terminal configured to receive the first logic power voltage and a second input terminal configured to receive the second logic power voltage. The second OR gate may include a first input terminal connected to an output terminal of the second comparator and a second input terminal connected to an output terminal of the third comparator. The first switching element may include a control electrode connected to an output terminal of the second OR gate, a first electrode configured to receive the first logic power voltage and a second electrode connected to the first input terminal of the first comparator. The second switching element may include a control electrode connected to the output terminal of the second OR gate, a first electrode configured to receive the second logic power voltage and a second electrode connected to the first input terminal of the first comparator.

In an embodiment, when the fault signal has an active level or the inverted enable signal has an active level, and when the fast discharge enable signal has an active level, the power voltage generator may be configured to compare the first logic power voltage to the logic threshold voltage.

In an embodiment, when the first logic power voltage is greater than the logic threshold voltage, the power voltage generator may be configured to determine the logic power voltage as the first logic power voltage.

In an embodiment, when the first logic power voltage is equal to or less than the logic threshold voltage, the first logic power voltage may be compared to the second logic power voltage. When the first logic power voltage is equal to or less than the logic threshold voltage and the first logic power voltage is greater than the second logic power voltage, the power voltage generator may be configured to determine the logic power voltage as the first logic power voltage.

In an embodiment, when the first logic power voltage is equal to or less than the logic threshold voltage, the first logic power voltage may be compared to the second logic power voltage. When the first logic power voltage is equal to or less than the logic threshold voltage and the first logic power voltage is equal to or less than the second logic power voltage, the power voltage generator may be configured to determine the logic power voltage as the second logic power voltage.

In an embodiment, the power voltage generator may further include a NOR gate, an AND gate, a first switching element and a second switching element. The NOR gate may include a first input terminal configured to receive the fault signal and a second input terminal configured to receive the inverted enable signal. The AND gate may include a first input terminal configured to receive a comparison result between the first logic power voltage and the logic threshold voltage and a second input terminal connected to an output terminal of the NOR gate. The first switching element may include a control electrode connected to an output terminal of the AND gate, a first electrode configured to receive the first logic power voltage and a second electrode connected to the discharge controller. The second switching element may include a control electrode connected to the output terminal of the AND gate, a first electrode configured to receive the second logic power voltage and a second electrode connected to the discharge controller.

In an embodiment, the first logic power voltage may be an input power voltage of the power voltage generator. The second logic power voltage may be an input/output (I/O) power voltage provided from outside the power voltage generator.

In an embodiment, when the first logic power voltage is greater than the logic threshold voltage, the fault signal has an inactive level and the inverted enable signal has an inactive level, an output level of the NOR gate may be logic high, an output level of the AND gate may be logic high and a logic power voltage of the discharge controller may be the first logic power voltage.

In an embodiment, when the fault signal has an active level or the inverted enable signal has an active level, an output level of the NOR gate may be logic low, an output level of the AND gate may be logic low and a logic power voltage of the discharge controller may be the second logic power voltage.

In an embodiment, when the first logic power voltage is equal to or less than the logic threshold voltage, an output level of the NOR gate may be logic low, an output level of the AND gate may be logic low and a logic power voltage of the discharge controller may be the second logic power voltage.

In an embodiment of a method of driving a display apparatus according to the present inventive concept, the method includes generating an output power voltage based on an input power voltage, during a normal mode. During, a fast discharge mode, the method may further include selectively applying one of a first logic power voltage or a second logic power voltage to a discharge controller connected to a control electrode of a discharge switching element to discharge the output power voltage, the discharge switching element being connected to an output terminal of a power voltage generator.

In an embodiment, when a logic power voltage of the discharge controller is determined as the first logic power voltage and when the first logic power voltage is equal to or greater than an operation threshold voltage, a fast discharge function may be enabled. When the logic power voltage of the discharge controller is determined as the first logic power voltage and when the first logic power voltage is less than the operation threshold voltage, the fast discharge function may be disabled. When the logic power voltage of the discharge controller is determined as the second logic power voltage and when the second logic power voltage is equal to or greater than the operation threshold voltage, the fast discharge function may be enabled. When the logic power voltage of the discharge controller is determined as the second logic power voltage and when the second logic power voltage is less than the operation threshold voltage, the fast discharge function may be disabled.

In an embodiment, the method may further include determining a logic power voltage of the discharge controller as the first logic power voltage when the first logic power voltage is greater than the logic threshold voltage, comparing the first logic power voltage to the second logic power voltage when the first logic power voltage is equal to or less than the logic threshold voltage, determining the logic power voltage as the first logic power voltage when a result of the comparing indicates the first logic power voltage is equal to or less than the logic threshold voltage and the first logic power voltage is greater than the second logic power voltage and determining the logic power voltage to the second logic power voltage when the result indicates the first logic power voltage is equal to or less than the logic threshold voltage and the first logic power voltage is equal to or less than the second logic power voltage.

In an embodiment of an electronic device according to the present inventive concept, the electronic device includes a display panel, a power voltage generator, a driving controller and a processor. The power voltage generator is configured to output a power voltage to the display panel. The driving controller is configured to control the power voltage generator. The processor is configured to output an input image data and an input control signal to the driving controller. The power voltage generator includes a discharge switching element connected to an output terminal of the power voltage generator and a discharge controller connected to a control electrode of the discharge switching element. The power voltage generator is configured to selectively apply one of a first logic power voltage or a second logic power voltage to the discharge controller.

According to one or more embodiments, a display apparatus, a method of driving the display apparatus and an electronic device including the display apparatus are provided. A power voltage generator of the display apparatus may include a discharge switching element and a discharge controller for controlling the discharge switching element. One of a first logic power voltage or a second logic power voltage may be selectively applied to the discharge controller to enhance reliability of a fast discharge function that quickly discharges the power voltage of a display panel of the display apparatus when the display apparatus is turned off or when input power voltage drops suddenly.

One or more of these embodiments may enable the fast discharge of the power voltage to be performed reliably, preventing defects such as line light-emission during power-down and thereby enhancing display quality.

### BRIEF DESCRIPTION OF THE DRAWINGS

The above and other features of the present inventive concept will become more apparent by describing in detailed embodiments thereof with reference to the accompanying drawings, in which:

FIG. 1 is a block diagram illustrating a display apparatus according to an embodiment of the present inventive concept;

FIG. 2 is a circuit diagram illustrating an example of a power voltage generator of FIG. 1;

FIG. 3 is a circuit diagram illustrating an example of a power voltage generator of FIG. 1;

FIG. 4A is a flowchart illustrating an operation of the power voltage generator of FIG. 3 when a logic power voltage is a first logic power voltage;

FIG. 4B is a flowchart illustrating an operation of the power voltage generator of FIG. 3 when the logic power voltage is a second logic power voltage;

FIG. 5 is a circuit diagram illustrating an example of a power voltage generator of FIG. 1;

FIG. 6 is a flowchart illustrating an operation of the power voltage generator of FIG. 5 according to an embodiment of the present inventive concept;

FIG. 7A is a diagram illustrating an operation of a fast discharge function of a power voltage generator according to a comparative embodiment;

FIG. 7B is a diagram illustrating an operation of a fast discharge function of the power voltage generator of FIG. 1;

FIG. 8 is a circuit diagram illustrating an example of a power voltage generator of a display apparatus according to an embodiment of the present inventive concept;

FIG. 9 is a table illustrating an operation of the power voltage generator of FIG. 8;

FIG. 10 is a block diagram illustrating an electronic apparatus according to an embodiment of the present inventive concept;

FIG. 11 is a block diagram illustrating an electronic apparatus according to an embodiment of the present inventive concept; and

FIG. 12 illustrates schematic diagrams of the electronic apparatuses of FIG. 11.

### DETAILED DESCRIPTION

Hereinafter, embodiments of the present inventive concept will be explained in detail with reference to the accompanying drawings.

One or more of these embodiments may be directed to a display apparatus including a display panel and a power voltage generator that supplies a power voltage to the display panel. The power voltage generator may include a discharge switching element connected to an output terminal of the power voltage generator for discharging a power voltage of the display panel and a discharge controller connected to a control electrode of the discharge switching element. One of a first logic power voltage or a second logic power voltage may be selectively applied to the discharge controller so that discharge of the power voltage is reliably performed when the display apparatus is turned off or when an input power supply suddenly decreases. This reliable discharge may prevent display defects such as line light-emission during power-down and enhance overall display quality. These embodiments may further extend to a method of driving the display apparatus and to an electronic apparatus including the display apparatus. Herein, the terms display device and display apparatus may be used interchangeably, and likewise the terms electronic device and electronic apparatus may be used interchangeably. Further as used herein, the term power voltage may refer to a supply voltage provided to the display panel for driving operation of its pixels and/or circuits, and the term logic power voltage may refer to a supply voltage provided to the discharge controller. The discharge controller may be referred to as a fast discharge controller and the discharge switching element may be referred to as a fast discharge switching element.

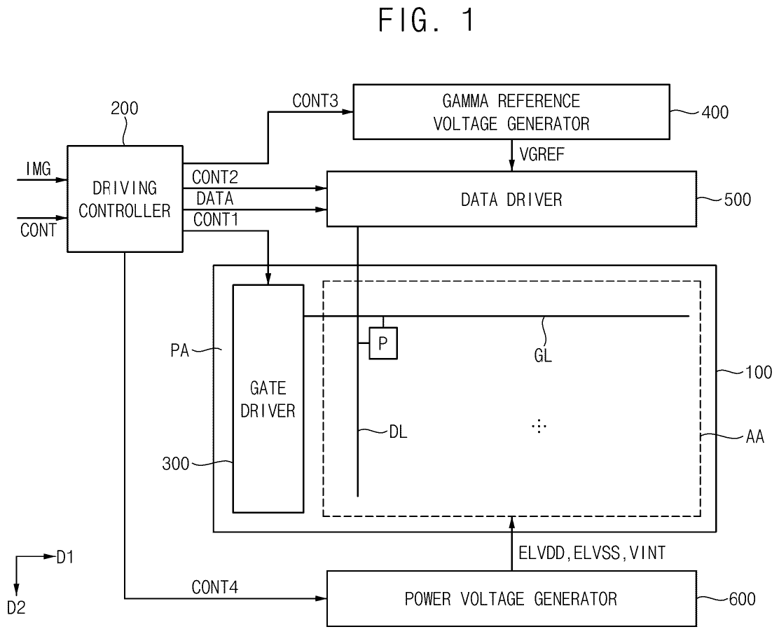

FIG. 1 is a block diagram illustrating a display apparatus according to an embodiment of the present inventive concept.

Referring to FIG. 1, the display apparatus includes a display panel 100 and a display panel driver (e.g., a first driver circuit). The display panel driver drives the display panel 100. The display panel driver includes a driving controller 200 (e.g., a controller circuit), a gate driver 300 (e.g., a second driver circuit), a gamma reference voltage generator 400, a data driver 500 (e.g., a third driver circuit) and a power voltage generator 600.

For example, the driving controller 200 and the data driver 500 may be integrally formed. For example, the driving controller 200, the gamma reference voltage generator 400 and the data driver 500 may be integrally formed. A driving module including at least the driving controller 200 and the data driver 500 which are integrally formed may be referred to as a timing controller embedded data driver (TED).

The display panel 100 has a display region AA on which an image is displayed and a peripheral region PA adjacent to or surrounding the display region AA.

The display panel 100 includes a plurality of gate lines GL, a plurality of data lines DL and a plurality of pixels P connected to the gate lines GL and the data lines DL. The gate lines GL may extend in a first direction D1 and the data lines DL may extend in a second direction D2 crossing the first direction D1.

The driving controller 200 receives input image data IMG and an input control signal CONT. The input control signal CONT may be received from an external apparatus (e.g. an application processor). For example, the input image data IMG may include red image data, green image data and blue image data. For example, the input image data IMG may include white image data. For example, the input image data IMG may include magenta image data, yellow image data and cyan image data. The input control signal CONT may include a master clock signal and a data enable signal. The master clock signal may be used to synchronize internal operations. The data enable signal may indicate when valid image data is present for latching. The input control signal CONT may further include a vertical synchronizing signal and a horizontal synchronizing signal. The vertical synchronizing signal may mark the start of a new frame and the horizontal synchronizing signal may mark the start of a new line within a frame.

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and outputs the first control signal CONT1 to the gate driver 300. The first control signal CONT1 may include a vertical start signal and a gate clock signal. The vertical start signal may inform the gate driver 300 where to start activating gate lines GL for a new frame. The gate clock signal may include timing pulses that sequentially shift the vertical start signal through stages of the gate driver 300, so that the gate lines GL may be driven sequentially or in groups depending on the driving scheme.

The driving controller 200 may generate the second control signal CONT2 for controlling an operation of the data driver 500 based on the input control signal CONT, and outputs the second control signal CONT2 to the data driver 500. The second control signal CONT2 may include a horizontal start signal and a load signal. The horizontal start signal may mark the beginning of a horizontal scanning sequence and indicate to the data driver 500 when to start outputting data voltages to a row of pixels. The load signal may control application of data voltages from the data driver 500 to the data lines DL.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the power voltage generator 600 based on the input control signal CONT, and output the fourth control signal CONT4 to the power voltage generator 600.

The gate driver 300 may generate gate signals for driving the gate lines GL in response to the first control signal CONT1 received from the driving controller 200. The gate driver 300 may output the gate signals to the gate lines GL. For example, the gate driver 300 may sequentially output the gate signals to the gate lines GL. For example, the gate driver 300 may be mounted on the peripheral region PA of the display panel 100. For example, the gate driver 300 may be integrated on the peripheral region PA of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages having an analog type using the gamma reference voltages VGREF. The data driver 500 may output the data voltages to the data lines DL.

The power voltage generator 600 may generate one or more power voltages ELVDD, ELVSS and VINT in response to the fourth control signal CONT4 received from the driving controller 200. The power voltage generator 600 may provide the power voltages ELVDD, ELVSS and VINT to the display panel 100. For example, a first one of the power voltages may be a high power voltage ELVDD applied to the pixel P. For example, a second one of the power voltages may be a low power voltage ELVSS applied to the pixel P. For example, a third one of the power voltages may be an initialization power voltage VINT applied to the pixel P. In an embodiment, the low power voltage ELVSS may be a ground voltage. In an embodiment, the high power voltage ELVDD is a positive voltage and the low power voltage ELVSS is a negative voltage.

In addition, the power voltage generator 600 may generate an analog power voltage for the data driver 500 and output the analog power voltage to the data driver 500. In addition, the power voltage generator 600 may generate a gate high power voltage and a gate low power voltage for the gate driver 300 and output the gate high power voltage and the gate low power voltage to the gate driver 300.

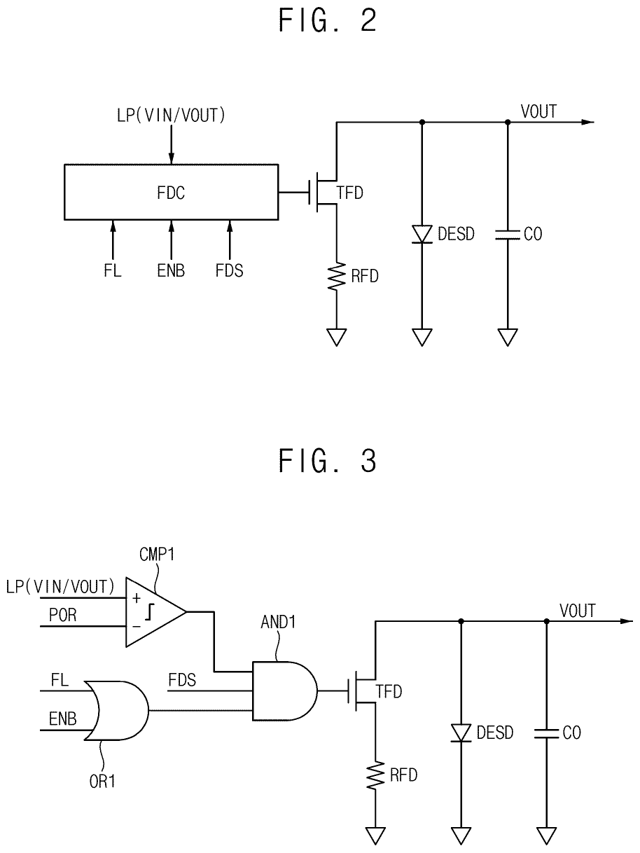

FIG. 2 is a circuit diagram illustrating an example of the power voltage generator 600 of FIG. 1.

Referring to FIGS. 1 and 2, the power voltage generator 600 may include a discharge switching element TFD connected to an output terminal of the power voltage generator 600 and a discharge controller FDC connected to a control electrode of the discharge switching element TFD. For example, the discharge switching element TFD may be implemented using a transistor, such as a metal-oxide-semiconductor field-effect transistor (MOSFET), a p-channel MOSFET (PMOS), or a thin-film transistor (TFT), with characteristics such as low on-resistance and fast switching speed selected to enable rapid and reliable discharge of the power voltage, which may differ from transistors used elsewhere in the apparatus. A first logic power voltage VIN and a second logic power voltage VOUT may be selectively applied to the discharge controller FDC.

The discharge switching element TFD may further include a first electrode connected to the output terminal of the power voltage generator 600 and a second electrode connected to a discharge resistor RFD. When the discharge switching element TFD is implemented by a transistor, a gate electrode of the transistor may receive a control signal from the discharge controller FDC.

The discharge resistor RFD may include a first end connected to the second electrode of the discharge switching element TFD and a second end connected to a ground. The discharge resistor RFD may be implemented using an integrated polysilicon resistor, a diffused resistor, or a thin-film resistor, with resistance characteristics chosen to balance discharge speed and current control, which may differ from resistors used in other portions of the apparatus. The discharge resistor RFD may be referred to as a fast discharge resistor.

The power voltage generator 600 may further include a diode DESD including a first electrode connected to the output terminal and a second electrode connected to the ground.

The power voltage generator 600 may further include a capacitor CO including a first electrode connected to the output terminal and a second electrode connected to the ground.

In the present embodiment, the first logic power voltage VIN may be an input power voltage of the power voltage generator 600. The second logic power voltage VOUT may be an output power voltage of the output terminal of the power voltage generator 600. The output power voltage of the output terminal of the power voltage generator 600 may be one of the high power voltage ELVDD, the low power voltage ELVSS and the initialization power voltage VINT.

The discharge controller FDC may receive a fault signal FL indicating an abnormal operation of the display apparatus, an inverted enable signal ENB indicating that the input power voltage VIN is equal to or less than a logic threshold voltage and a fast discharge enable signal FDS indicating that the fast discharge function is enabled.

The discharge controller FDC may control at least one of the discharge switching element TFD based on the fault signal FL, the inverted enable signal ENB and the fast discharge enable signal FDS. For example, the discharge controller FDC may control the discharge switching element TFD based on the first logic power voltage VIN, the second logic power voltage VOUT, an operation threshold voltage, the fault signal FL, the inverted enable signal ENB and the fast discharge enable signal FDS.

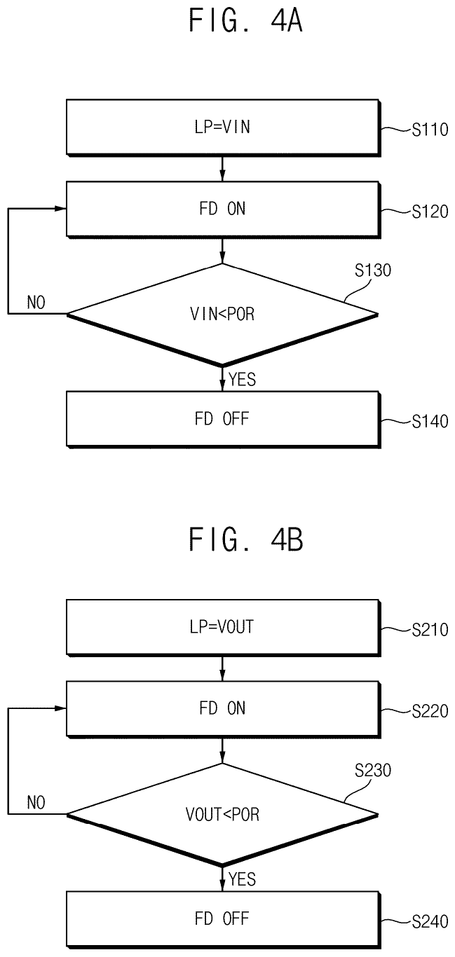

FIG. 3 is a circuit diagram illustrating an example of the power voltage generator 600 of FIG. 1. FIG. 4A is a flowchart illustrating an operation of the power voltage generator 600 of FIG. 3 when a logic power voltage LP is the first logic power voltage VIN. FIG. 4B is a flowchart illustrating an operation of the power voltage generator 600 of FIG. 3 when the logic power voltage LP is the second logic power voltage VOUT.

FIG. 3 illustrates a detailed circuit configuration of the discharge controller FDC.

Referring to FIGS. 1 to 3, the discharge controller FDC may include a first comparator CMP1, a first OR gate OR1 and a first AND gate AND1. The first comparator CMP1 may include a first input terminal receiving one of the first logic power voltage VIN and the second logic power voltage VOUT and a second input terminal receiving an operation threshold voltage POR. The first comparator CMP1 may be implemented by a comparison circuit such an operational amplifier. The first OR gate OR1 may include a first input terminal receiving the fault signal FL and a second input terminal receiving the inverted enable signal ENB. The first AND gate AND1 may include a first input terminal connected to an output terminal of the first comparator CMP1, a second input terminal receiving the fast discharge enable signal FDS and a third input terminal connected to an output terminal of the first OR gate OR1.

An output terminal of the first AND gate AND1 may be connected to the control electrode of the discharge switching element TFD.

For example, when the logic power voltage LP is equal to or greater than the operation threshold voltage POR, an output of the first comparator CMP1 may be at a logic high level or one. For example, when the logic power voltage LP is less than the operation threshold voltage POR, the output of the first comparator CMP1 may be at a logic low level or zero.

When the abnormal operation of the display apparatus is detected, the fault signal FL may have an active level (e.g., logic high level or one). When the abnormal operation of the display apparatus is not detected, the fault signal FL may have an inactive level (e.g., logic low level or zero).

In an embodiment, the input power voltage VIN and an enable signal are input to the power voltage generator 600 through a same connector pin. The inverted enable signal ENB may be determined by a level of the input power voltage VIN.

For example, when the input power voltage VIN is greater than the logic threshold voltage, the enable signal has an active level of one and the inverted enable signal ENB has an inactive level (e.g., logic low or zero).

In contrast, when the input power voltage VIN is equal to or less than the logic threshold voltage, the enable signal has an inactive level (e.g., logic low or zero) and the inverted enable signal ENB has an active level (e.g., logic high or one).

When the fast discharge function is enabled, the fast discharge enable signal FDS may have an active level (e.g., logic high or one). In contrast, when the fast discharge function is disabled, the fast discharge enable signal FDS may have an inactive level (e.g., logic low or zero).

For example, when the abnormal operation of the display apparatus is detected (FL=1) or the input power voltage VIN is equal to or less than the logic threshold voltage (ENB=1), an output signal of the first OR gate OR1 may be activated.

When the output signal of the first OR gate OR1 is activated (logic high or one), the fast discharge function is enabled (FDS=1). In addition, when the logic power voltage LP is equal to or greater than the operation threshold voltage POR (the output signal of the first comparator CMP1 is logic high or one), the discharge controller FDC may turn on the fast discharge switching element TFD. As a result, the output power voltage VOUT of the power voltage generator 600 may be discharged.

As shown in FIG. 4A, when the logic power voltage LP of the discharge controller FDC is determined as the first logic power voltage VIN (operation S110) and when the first logic power voltage VIN is equal to or greater than the operation threshold voltage POR (operation S130: NO), the fast discharge function is enabled (operation S120). When the logic power voltage LP of the discharge controller FDC is determined as the first logic power voltage VIN (operation S110) and when the first logic power voltage VIN is less than the operation threshold voltage POR (operation S130: YES), the fast discharge function is disabled (operation S140).

As shown in FIG. 4B, when the logic power voltage LP of the discharge controller FDC is determined as the second logic power voltage VOUT (operation S210) and when the second logic power voltage VOUT is equal to or greater than the operation threshold voltage POR (operation S230: NO), the fast discharge function is enabled (operation S220). When the logic power voltage LP of the discharge controller FDC is determined as the second logic power voltage VOUT (operation S210) and when the second logic power voltage VOUT is less than the operation threshold voltage POR (operation S230: YES), the fast discharge function is disabled (operation S240).

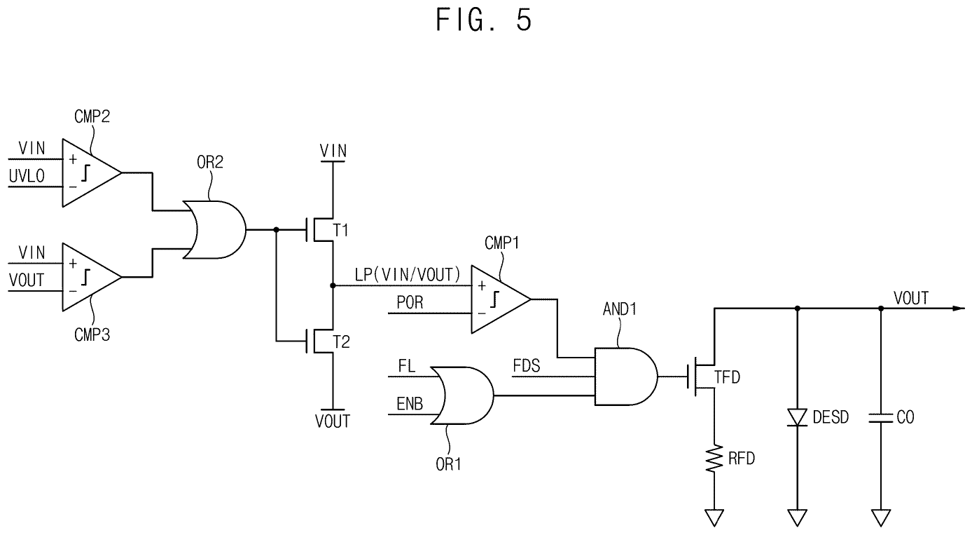

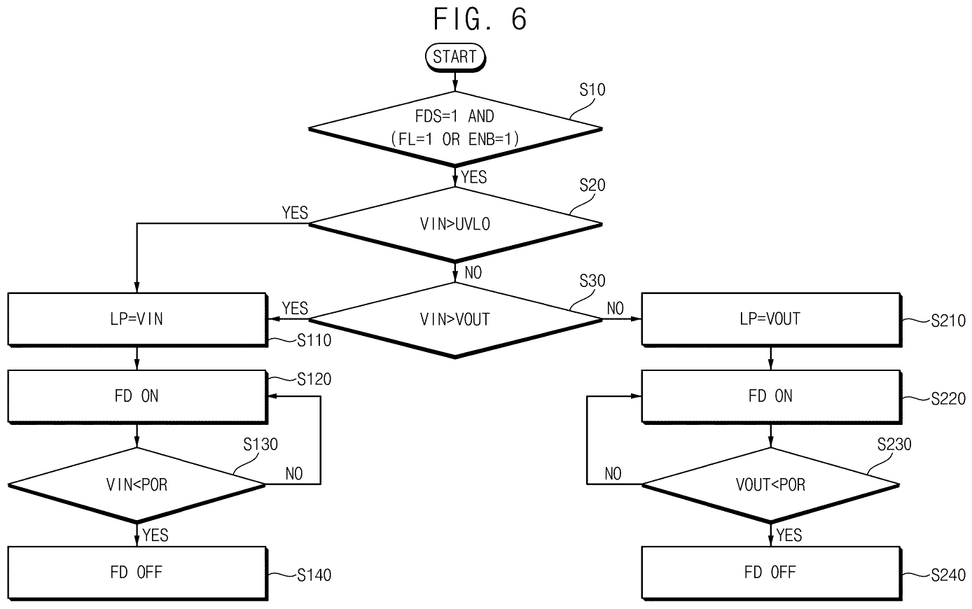

FIG. 5 is a circuit diagram illustrating an example of the power voltage generator 600 of FIG. 1. FIG. 6 is a flowchart illustrating an operation of the power voltage generator 600 of FIG. 5.

FIG. 5 illustrates a detailed circuit configuration of a logic power voltage applier selectively applying one of the first logic power voltage VIN and the second logic power voltage VOUT.

Referring to FIGS. 1 to 6, the power voltage generator 600 may further include a second comparator CMP2, a third comparator CMP3, a second OR gate OR2, a first switching element T1 and a second switching element T2. The second comparator CMP2 may include a first input terminal receiving the first logic power voltage VIN and a second input terminal receiving the logic threshold voltage UVLO. The third comparator CMP3 may include a first input terminal receiving the first logic power voltage VIN and a second input terminal receiving the second logic power voltage VOUT. The second OR gate OR2 may include a first input terminal connected to an output terminal of the second comparator CMP2 and a second input terminal connected to an output terminal of the third comparator CMP3. The first switching element T1 (e.g., a first transistor) may include a control electrode connected to an output terminal of the second OR gate OR2, a first electrode receiving the first logic power voltage VIN and a second electrode connected to the first input terminal of the first comparator CMP1. The second switching element T2 (e.g., a second transistor T2) may include a control electrode connected to the output terminal of the second OR gate OR2, a first electrode receiving the second logic power voltage VOUT and a second electrode connected to the first input terminal of the first comparator CMP1.

For example, when the first logic power voltage VIN is greater than the logic threshold voltage UVLO, an output signal of the second comparator CMP2 may be logic high or one.

For example, when the first logic power voltage VIN is greater than the second logic power voltage VOUT, an output signal of the third comparator CMP3 may be logic high or one.

When the fault signal FL has an active level, the inverted enable signal ENB has an active level and the fast discharge enable signal FS has an active level (operation S10), the power voltage generator 600 may compare the first logic power voltage VIN to the logic threshold voltage UVLO (operation S20).

When the first logic power voltage VIN is greater than the logic threshold voltage UVLO (operation S20: YES), the power voltage generator 600 may determine the logic power voltage LP as the first logic power voltage VIN.

When the first logic power voltage VIN is equal to or less than the logic threshold voltage UVLO (operation S20: NO), the first logic power voltage VIN may be compared to the second logic power voltage VOUT (operation S30).

When the first logic power voltage VIN is equal to or less than the logic threshold voltage UVLO (operation S20: NO) and the first logic power voltage VIN is greater than the second logic power voltage VOUT (operation S30: YES), the power voltage generator 600 may determine the logic power voltage LP as the first logic power voltage VIN (operation S110).

When the first logic power voltage VIN is equal to or less than the logic threshold voltage UVLO (operation S20: NO) and the first logic power voltage VIN is equal to or less than the second logic power voltage VOUT (operation S30: NO), the power voltage generator 600 may determine the logic power voltage LP as the second logic power voltage VOUT (operation S210).

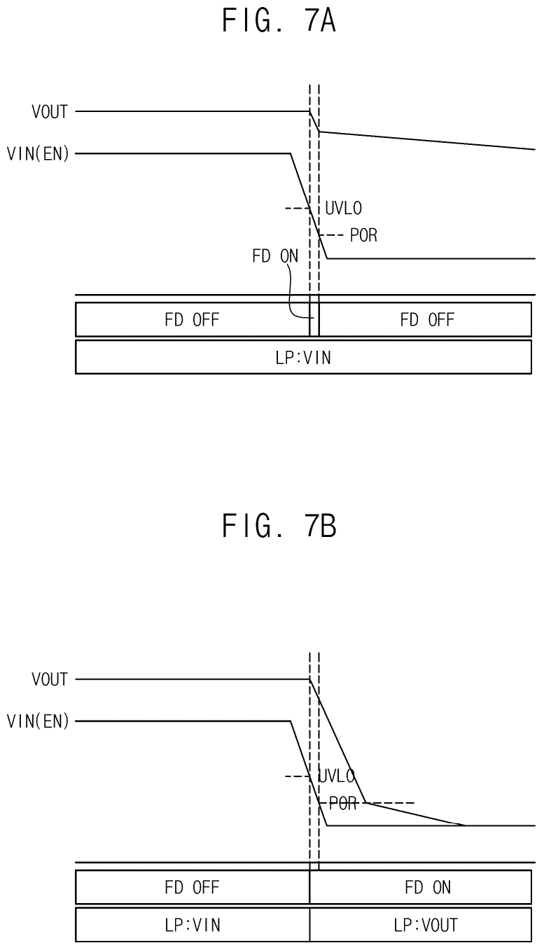

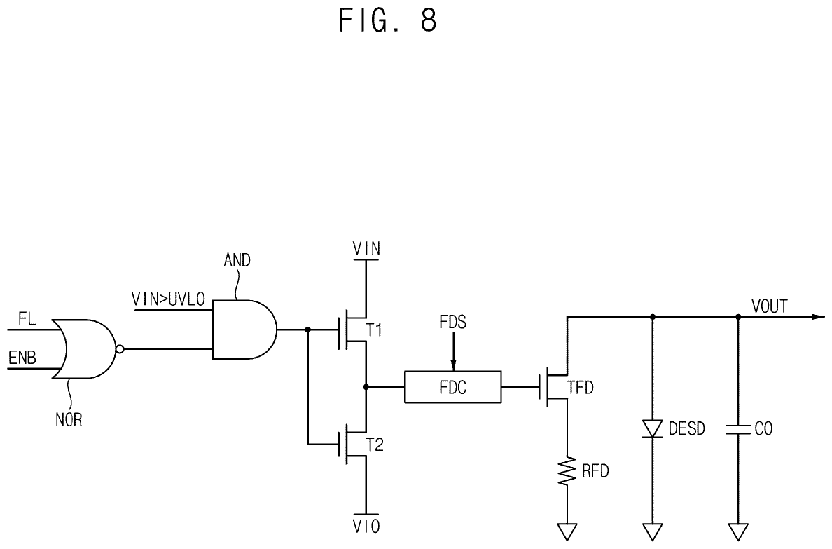

FIG. 7A is a diagram illustrating an operation of a fast discharge function of a power voltage generator according to a comparative embodiment. FIG. 7B is a diagram illustrating an operation of a fast discharge function of the power voltage generator 600 of FIG. 1.

The fast discharge function of a power voltage generator according to the comparative embodiment may be performed using only the first logic power voltage VIN. Thus, when the display apparatus is turned off due to a rapid decrease in a battery voltage caused by an external factor, an internal logic (e.g., VIN) of the power voltage generator may be disabled before an output voltage of the power voltage generator is discharged. As a result, a fast discharge function may not be performed normally.

As shown in FIG. 7A, when a level of the first logic power voltage VIN decreases below the logic threshold voltage UVLO, the fast discharge operation may start. When the level of the first logic power voltage VIN gradually decreases, the fast discharge operation may be performed normally. However, when the level of the first logic power voltage VIN rapidly decreases below the operation threshold voltage POR, an operation of the power voltage generator is impossible so that the fast discharge operation may not be performed normally.

The fast discharge function of the power voltage generator 600 according to the present embodiment may be performed using the first logic power voltage VIN and the second logic power voltage VOUT.

As shown in FIG. 7B, when a level of the first logic power voltage VIN decreases below the logic threshold voltage UVLO, the fast discharge operation may start. Although the level of the first logic power voltage VIN rapidly decreases below the operation threshold voltage POR, the fast discharge operation is performed using the second logic power voltage VOUT so that the fast discharge operation may be performed normally.

A method of driving the display apparatus according to an embodiment of the present inventive concept may include generating the output power voltage VOUT based on the input power voltage VIN during a normal mode. The method may further include outputting the output power voltage VOUT to the display panel 100 during the normal mode. In addition, during a fast discharge mode, the method may include selectively applying one of the first logic power voltage VIN and the second logic power voltage VOUT to the discharge controller FDC, which is connected to a control electrode of a discharge switching element to discharge the output power voltage VOUT.

According to the present embodiment, the power voltage generator 600 includes the discharge switching element TFD and the discharge controller FDC for controlling the discharge switching element TFD. One of the first logic power voltage VIN and the second logic power voltage VOUT may be selectively applied to the discharge controller FDC. In this way, reliability of the fast discharge function may be increased. The fast discharge function may quickly discharge a power voltage (e.g. ELVDD, ELVSS and VINT) of the display panel 100 when the display apparatus is turned off or when the input power voltage VIN drops suddenly.

The fast discharge function may be performed reliably, preventing display defects such as line light-emission in which some lines of the display panel 100 remain lit during power-down. As a result, the display quality of the display panel 100 may be enhanced.

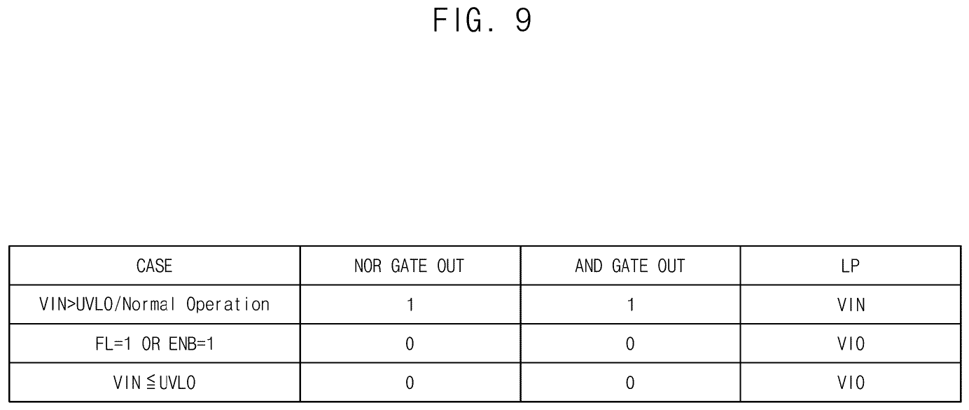

FIG. 8 is a circuit diagram illustrating an example of a power voltage generator of a display apparatus according to an embodiment of the present inventive concept. FIG. 9 is a table illustrating an operation of the power voltage generator of FIG. 8.

The display apparatus and the method of driving the display apparatus according to the present embodiment are substantially the same as the display apparatus and the method of driving the display apparatus of the previous embodiment explained referring to FIGS. 1 to 7B except for an operation and a structure of the power voltage generator. Thus, the same reference numerals will be used to refer to the same or like parts as those described in the previous embodiment of FIGS. 1 to 7B and any repetitive explanation concerning the above elements will be omitted.

Referring to FIGS. 1, 8 and 9, the power voltage generator 600 may include a discharge switching element TFD connected to an output terminal of the power voltage generator 600 and a discharge controller FDC connected to a control electrode of the discharge switching element TFD. A first logic power voltage VIN and a second logic power voltage VIO may be selectively applied to the discharge controller FDC.

The discharge switching element TFD may further include a first electrode connected to the output terminal of the power voltage generator 600 and a second electrode connected to a discharge resistor RFD.

In the present embodiment, the first logic power voltage VIN may be an input power voltage of the power voltage generator 600. The second logic power voltage VIO may be an input/output (I/O) power voltage VIO provided from outside the power voltage generator 600. The second logic power voltage VIO may be provided from outside the power voltage generator 600 regardless of the input power voltage VIN. Thus, although a level of the input power voltage VIN decreases, the fast discharge operation may be continuously performed.

The power voltage generator 600 may further include a NOR gate NOR, an AND gate AND, a first switching element T1 and a second switching element T2. The NOR gate NOR may include a first input terminal receiving the fault signal FL and a second input terminal receiving the inverted enable signal ENB. The AND gate AND may include a first input terminal receiving a comparison result between the first logic power voltage VIN and the logic threshold voltage UVLO and a second input terminal connected to an output terminal of the NOR gate NOR. For example, the comparison result may indicate whether the first logic power voltage VIN is greater than the logic threshold voltage UVLO. The first switching element T1 may include a control electrode connected to an output terminal of the AND gate AND, a first electrode receiving the first logic power voltage VIN and a second electrode connected to the discharge controller FDC. The second switching element T2 may include a control electrode connected to the output terminal of the AND gate AND, a first electrode receiving the second logic power voltage VIO and a second electrode connected to the discharge controller FDC.

As shown in FIG. 9, when the first logic power voltage VIN is greater than the logic threshold voltage UVLO, the fault signal FL has the inactive level and the inverted enable signal ENB has the inactive level, the output level of the NOR gate NOR may be logic high or one, the output level of the AND gate AND may be logic high or one and the logic power voltage LP of the discharge controller FDC may switch to the first logic power voltage VIN.

When either the fault signal FL has the active level or the inverted enable signal ENB has the active level (FL=1 OR ENB=1), the output level of the NOR gate NOR may be logic low or zero. Accordingly, the output level of the AND gate AND may be a logic low or zero. As a result, the logic power voltage LP of the discharge controller FDC may switch to the second logic power voltage VIO.

When the first logic power voltage VIN is equal to or less than the logic threshold voltage UVLO, the output level of the NOR gate NOR may be logic low or zero. Accordingly, the output level of the AND gate AND may be logic low or zero. As a result, the logic power voltage LP of the discharge controller FDC may switch to the second logic power voltage VIO.

Although not shown in FIG. 8 in detail, a structure of the discharge controller FDC may be substantially the same as the structure of the discharge controller FDC of FIG. 3 and the structure of the discharge controller FDC of FIG. 5.

Although not shown in FIG. 8 in detail, the first input terminal of the AND gate AND may be connected to an output of a comparator receiving the first logic power voltage VIN and the logic threshold voltage UVLO.

According to the present embodiment, the power voltage generator 600 includes the discharge switching element TFD and the discharge controller FDC for controlling the discharge switching element TFD. One of the first logic power voltage VIN and the second logic power voltage VIO may be selectively applied to the discharge controller FDC. In this way, the reliability of a fast discharge function may be increased. The fast discharge function may quickly discharge a power voltage (e.g. ELVDD, ELVSS and VINT) of the display panel 100 when the display apparatus is turned off or when the input power voltage VIN drops suddenly.

The fast discharge function may be performed reliably, thereby preventing display defects such as line light-emission in which some lines of the display panel 100 remain lit during power-down. As a result, the display quality of the display panel 100 may be enhanced.

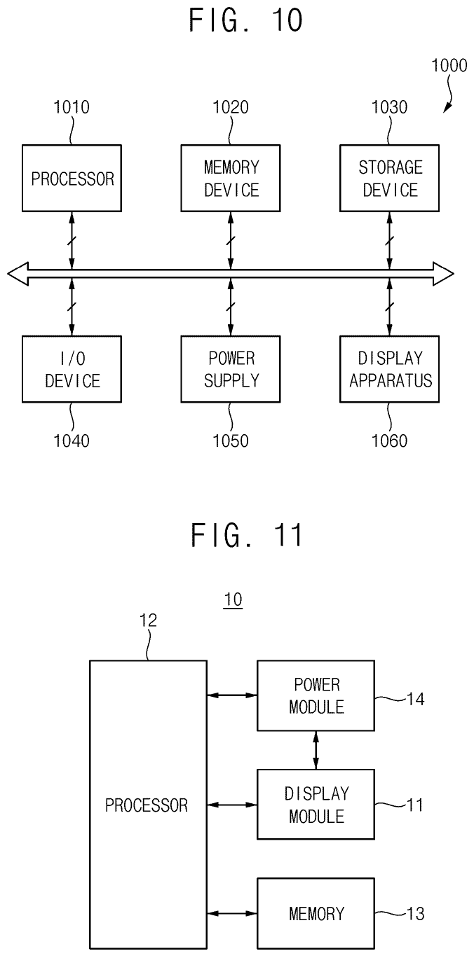

FIG. 10 is a block diagram illustrating an electronic apparatus 1000 (e.g., an electronic device) according to an embodiment of the present inventive concept.

Referring to FIGS. 1 to 10, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

For example, the electronic apparatus 1000 may be implemented as a smart phone, a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

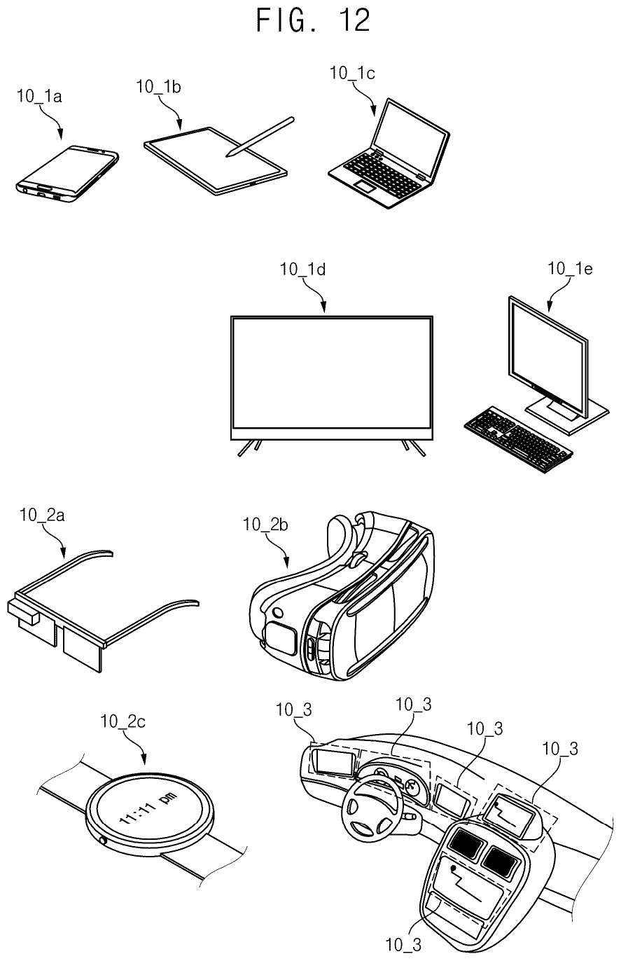

FIG. 11 is a block diagram illustrating an electronic apparatus 10 according to an embodiment of the present inventive concept. FIG. 12 illustrates schematic diagrams of the electronic apparatuses 10 of FIG. 11.

Referring to FIG. 11, the electronic apparatus 10 according to an embodiment may include a display module 11, a processor 12, a memory 13 and a power module 14.

The display apparatus according to the embodiment of the present inventive concept may be applied to various electronic apparatuses.

In an embodiment, the electronic apparatus 10 may include the display apparatus of FIG. 1. An operation of the display apparatus included in the electronic apparatus 10 may be substantially the same as the operation of the display apparatus explained referring to FIGS. 1 to 9. The electronic apparatus 10 may further include a module or an apparatus having additional functions in addition to the display apparatus.

The processor 12 may include at least one of a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display apparatus of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display apparatus of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic apparatus 10.

At least one of the elements of the electronic apparatus 10 may be included in the display apparatus according to embodiments of the present inventive concept. In addition, a part of a single functional module may be included in the display apparatus and another part of the single functional module may be disposed out of the display apparatus. For example, the display module 11 may be included in the display apparatus but the processor 12, the memory 13 and the power module 14 may be included in another apparatus in the electronic apparatus 10 which is not the display apparatus.

Referring to FIG. 12, the various electronic apparatuses including the display apparatus according to the present embodiments may include electronic apparatuses for displaying image such as a smartphone 10_1a, a tablet PC 10_1b, a laptop 10_1c, a television 10_1d, a desktop monitor 10_1e, wearable electronic apparatuses including a display module such as smart glasses 10_2a, a head mounted display 10_2b and a smart watch 10_2c and vehicle electronic apparatuses 10_3 including display modules such as a CID (center information display), a room mirror display disposed on an instrument panel, center fascia, and a dashboard of a vehicle. The electronic apparatus 10 may not be limited to the electronic apparatuses for displaying image, the wearable electronic apparatuses and the vehicle electronic apparatuses 10_3.

According to the display apparatus, the method of driving the display apparatus and the electronic apparatus including the display apparatus of the present embodiment as explained above, the reliability of the fast discharge function may be enhanced, the display defect may be prevented and the display quality of the display panel may be enhanced.

The foregoing is illustrative of the present inventive concept and is not to be construed as limiting thereof. Although a few example embodiments of the present inventive concept have been described, those skilled in the art will readily appreciate that many modifications are possible in the example embodiments without materially departing from the present inventive concept. Accordingly, all such modifications are intended to be included within the scope of the present inventive concept. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims.

What is claimed is:

1. A display apparatus comprising:
a display panel; and
a power voltage generator configured to output a power voltage to the display panel,
wherein the power voltage generator comprises:
a discharge switching element connected to an output terminal of the power voltage generator; and
a discharge controller connected to a control electrode of the discharge switching element, and
wherein the power voltage generator is configured to selectively apply one of a first logic power voltage or a second logic power voltage to the discharge controller.

2. The display apparatus of claim 1, wherein the first logic power voltage is an input power voltage of the power voltage generator, and
wherein the second logic power voltage is an output power voltage of the output terminal of the power voltage generator.

3. The display apparatus of claim 1, wherein the discharge controller is configured to receive a fault signal indicating an abnormal operation of the display apparatus, an inverted enable signal indicating that an input power voltage is equal to or less than a logic threshold voltage and a fast discharge enable signal indicating whether to discharge the power voltage.

4. The display apparatus of claim 3, wherein the discharge controller comprises:
a first comparator including a first input terminal configured to receive one of the first logic power voltage and a second logic power voltage and a second input terminal configured to receive an operation threshold voltage;
a first OR gate including a first input terminal configured to receive the fault signal and a second input terminal configured to receive the inverted enable signal; and
a first AND gate including a first input terminal connected to an output terminal of the first comparator, a second input terminal configured to receive the fast discharge enable signal and a third input terminal connected to an output terminal of the first OR gate, and
wherein an output terminal of the first AND gate is connected to the discharge switching element.

5. The display apparatus of claim 4, wherein when a logic power voltage of the discharge controller is determined as the first logic power voltage and when the first logic power voltage is equal to or greater than the operation threshold voltage, a fast discharge function is enabled, and
wherein when the logic power voltage of the discharge controller is determined as the first logic power voltage and when the first logic power voltage is less than the operation threshold voltage, the fast discharge function is disabled.

6. The display apparatus of claim 4, wherein when a logic power voltage of the discharge controller is determined as the second logic power voltage and when the second logic power voltage is equal to or greater than the operation threshold voltage, a fast discharge function is enabled, and
wherein when the logic power voltage of the discharge controller is determined as the second logic power voltage and when the second logic power voltage is less than the operation threshold voltage, the fast discharge function is disabled.

7. The display apparatus of claim 4, wherein the power voltage generator further comprises:
a second comparator including a first input terminal configured to receive the first logic power voltage and a second input terminal configured to receive the logic threshold voltage;
a third comparator including a first input terminal configured to receive the first logic power voltage and a second input terminal configured to receive the second logic power voltage;
a second OR gate including a first input terminal connected to an output terminal of the second comparator and a second input terminal connected to an output terminal of the third comparator;
a first switching element including a control electrode connected to an output terminal of the second OR gate, a first electrode configured to receive the first logic power voltage and a second electrode connected to the first input terminal of the first comparator; and
a second switching element including a control electrode connected to the output terminal of the second OR gate, a first electrode configured to receive the second logic power voltage and a second electrode connected to the first input terminal of the first comparator.

8. The display apparatus of claim 7, wherein when the fault signal has an active level or the inverted enable signal has an active level, and when the fast discharge enable signal has an active level, the power voltage generator is configured to compare the first logic power voltage to the logic threshold voltage.

9. The display apparatus of claim 8, wherein when the first logic power voltage is greater than the logic threshold voltage, the power voltage generator is configured to determine the logic power voltage as the first logic power voltage.

10. The display apparatus of claim 8, wherein when the first logic power voltage is equal to or less than the logic threshold voltage, the first logic power voltage is compared to the second logic power voltage, and
wherein when the first logic power voltage is equal to or less than the logic threshold voltage and the first logic power voltage is greater than the second logic power voltage, the power voltage generator is configured to determine the logic power voltage as the first logic power voltage.

11. The display apparatus of claim 8, wherein when the first logic power voltage is equal to or less than the logic threshold voltage, the first logic power voltage is compared to the second logic power voltage, and
wherein when the first logic power voltage is equal to or less than the logic threshold voltage and the first logic power voltage is equal to or less than the second logic power voltage, the power voltage generator is configured to determine the logic power voltage as the second logic power voltage.

12. The display apparatus of claim 3, wherein the power voltage generator further comprises:
a NOR gate including a first input terminal configured to receive the fault signal and a second input terminal configured to receive the inverted enable signal;
an AND gate including a first input terminal configured to receive a comparison result between the first logic power voltage and the logic threshold voltage and a second input terminal connected to an output terminal of the NOR gate;
a first switching element including a control electrode connected to an output terminal of the AND gate, a first electrode configured to receive the first logic power voltage and a second electrode connected to the discharge controller; and
a second switching element including a control electrode connected to the output terminal of the AND gate, a first electrode configured to receive the second logic power voltage and a second electrode connected to the discharge controller.

13. The display apparatus of claim 12, wherein the first logic power voltage is an input power voltage of the power voltage generator, and
wherein the second logic power voltage is an input/output (I/O) power voltage provided from outside the power voltage generator.

14. The display apparatus of claim 12, wherein when the first logic power voltage is greater than the logic threshold voltage, the fault signal has an inactive level and the inverted enable signal has an inactive level, an output level of the NOR gate is logic high, an output level of the AND gate is logic high and a logic power voltage of the discharge controller is the first logic power voltage.

15. The display apparatus of claim 12, wherein when the fault signal has an active level or the inverted enable signal has an active level, an output level of the NOR gate is logic low, an output level of the AND gate is logic low and a logic power voltage of the discharge controller is the second logic power voltage.

16. The display apparatus of claim 12, wherein when the first logic power voltage is equal to or less than the logic threshold voltage, an output level of the NOR gate is logic low, an output level of the AND gate is logic low and a logic power voltage of the discharge controller is the second logic power voltage.

17. A method of driving a display apparatus, the method comprising:
generating an output power voltage based on an input power voltage and outputting the output power voltage to a display panel, during a normal mode; and
during a fast discharge mode, selectively applying one of a first logic power voltage or a second logic power voltage to a discharge controller connected to a control electrode of a discharge switching element to discharge the output power voltage, the discharge switching element being connected to an output terminal of a power voltage generator.

18. The method of claim 17, wherein when a logic power voltage of the discharge controller is determined as the first logic power voltage and when the first logic power voltage is equal to or greater than an operation threshold voltage, a fast discharge function is enabled,
wherein when the logic power voltage of the discharge controller is determined as the first logic power voltage and when the first logic power voltage is less than the operation threshold voltage, the fast discharge function is disabled,
wherein when the logic power voltage of the discharge controller is determined as the second logic power voltage and when the second logic power voltage is equal to or greater than the operation threshold voltage, the fast discharge function is enabled, and
wherein when the logic power voltage of the discharge controller is determined as the second logic power voltage and when the second logic power voltage is less than the operation threshold voltage, the fast discharge function is disabled.

19. The method of claim 17, further comprising:
determining a logic power voltage of the discharge controller as the first logic power voltage when the first logic power voltage is greater than the logic threshold voltage;
comparing the first logic power voltage to the second logic power voltage when the first logic power voltage is equal to or less than the logic threshold voltage;
determining the logic power voltage as the first logic power voltage when a result of the comparing indicates the first logic power voltage is equal to or less than the logic threshold voltage and the first logic power voltage is greater than the second logic power voltage; and
determining the logic power voltage as the second logic power voltage when the result indicates the first logic power voltage is equal to or less than the logic threshold voltage and the first logic power voltage is equal to or less than the second logic power voltage.

20. An electronic device comprising:
a display panel;
a power voltage generator configured to output a power voltage to the display panel;
a driving controller configured to control the power voltage generator; and
a processor configured to output an input image data and an input control signal to the driving controller,
wherein the power voltage generator comprises:
a discharge switching element connected to an output terminal of the power voltage generator; and
a discharge controller connected to a control electrode of the discharge switching element, and
wherein the power voltage generator is configured to selectively apply one of a first logic power voltage or a second logic power voltage to the discharge controller.
